(19) United States
(12) Patent Application Publication
(10) Pub. No.: US 2009/0002134 A1
(43) Pub. Date: Jan. 1, 2009

(54) Systems, Methods, and Devices for Commissioning Wireless Sensors

(76) Inventor: CLARKE McALLISTER, EUGENE, OR (US)

Correspondence Address: PETER A. HAAS, ESQUIRE, 1929 SW 13TH AVENUE, PORTLAND, OR, 97201, US

(21) Appl. No.: 12/055,617

(22) Filed: Mar. 26, 2008

Related U.S. Application Data
(60) Provisional application No. 60/908,194, filed on Mar. 27, 2007.

(51) Int. Cl. H04Q 5/22

(52) U.S. Cl. 340/10.51; 340/572.8

(57) ABSTRACT

In one preferred embodiment the present invention is an encoder for commissioning RFID transponders and includes a housing encasing a motor assembly, a motion and displacement sensor, wireless communication means for transferring instructions and data from and to a remote host, on-board memory, a processor, and an antenna with corresponding mechanism to encode and verify a programmable RFID transponder within a protective enclosure. The present invention further includes novel methods for commissioning RFID transponders, as well as methods for recycling and reusing the protective enclosure.

### PRIORITY CLAIM

This present application claims benefit under 35 U.S.C. Section 119(e) of U.S. Provisional Patent Application Ser. No. 60/908,194, filed on 27 Mar. 2007, the disclosure of which is expressly incorporated by reference for all purposes.

### BACKGROUND

The present invention relates to a system, including methods and devices, utilizing wireless sensor devices and RFID (radio-frequency identification) transponders. Specifically, the present invention relates to a system incorporating novel devices and methods that enable point-of-use and on-demand commissioning of RFID transponder-equipped wireless sensors.

Radio-frequency identification (RFID) transponders enable improved identification and tracking of objects by encoding data electronically in a compact tag or label. And, advantageously, the compact tag or label does not need external, optically recognizable or human-readable markings. In fact, using the Gen2 EPC specification, a three-meter read-distance for RFID transponders is common—even on high-speed material handling lines.

Radio-frequency identification (RFID) transponders, typically thin transceivers that include an integrated circuit chip having radio frequency circuits, control logic, memory and an antenna structure mounted on a supporting substrate, enable vast amounts of information to be encoded and stored and have unique identification. Commissioning, the process of encoding specific information (for example, data representing an object identifier, the date-code, batch, customer name, origin, destination, quantity, and items) associated with an object (for example, a shipping container), associates a specific object with a unique RFID transponder. The commissioned transponder responds to coded RF signals and, therefore, readily can be interrogated by external devices to reveal the data associated with the transponder.

Current classes of RFID transponders rank into two primary categories: active RFID transponders and passive RFID transponders. Active RFID transponders include an integrated power source capable of self-generating signals, which may be used by other, remote reading devices to interpret the data associated with the transponder. Active transponders include batteries and, historically, are considered considerably more expensive than passive RFID transponders. Passive RFID transponders backscatter incident RF energy to specially designed remote devices such as interrogators.

Combining the benefits of the latest technology in RFID transponders with sensing devices, a broader class of devices called wireless sensors is emerging. Wireless sensors have a unique identity, sense one or more attributes within its environment, and report its identity and data corresponding to the sensed attributes. For example, a wireless sensor interprets environmental conditions such as temperature, moisture, sunlight, seismic activity, biological, chemical or nuclear materials, specific molecules, shock, vibration, location, or other environmental parameters. Wireless sensors are distributed nodes of computing networks that are interconnected by wired and wireless interfaces.

Wireless sensors, made using silicon circuits, polymer circuits, optical modulation indicia, an encoded quartz crystal diode, or Surface Acoustic Wave (SAW) materials to affect radio frequency or other signaling methods, communicate wirelessly to other devices. For example, certain embodiments of wireless sensors communicate on a peer-to-peer basis to an interrogator or a mobile computer. Communication methods include narrow band, wide band, ultra wide band, or other means of radio or signal propagation methods.

Additional examples of RFID transponders, wireless tags, and wireless sensors are more fully discussed this inventor's co-pending U.S. Patent Application Publication No. 2006/0080819, entitled “Systems and Methods for Deployment and Recycling of RFID Tags, Wireless Sensors, and the Containers Attached thereto,” published on 20 Apr. 2006, which is incorporated by reference for all purposes in this document.

One problem of prior-art systems, such as conventional print labels or barcode systems, includes a requirement for line of sight and an overdependence on the optical quality of the label. Many factors can render such a label unreadable including printing errors, excess ink, insufficient ink, physical destruction of the markings, obstruction of the markings due to foreign matter, and, in extreme cases, outright deception by placing an altered label over the top of such a print label.

RFID transponder labeling eliminates the need for an optically readable print label and overcomes all of the shortcomings related to print quality and the need for line of sight to scan the label. Moreover, RFID transponder labels enable secure data encryption, making outright deception considerably less likely to occur. However, current RFID label systems have their own limitations as well.

For example, certain prior art systems, as represented by U.S. Pat. No. 7,066,667 issued to Chapman et al. on 27 Jun. 2006 and include U.S. Pat. No. 5,899,476 issued to Barrus et al. on 31 May 2005, or by U.S. Pat. No. 6,246,326 issued to Wiklof et al. on 12 Jun. 2001, describe a device that commissions an RFID transponder with a printed label. This approach, however, introduces unnecessary waste, cost, and propensities for error. There is a growing category of applications that do not require anything other than a custom-encoded RFID transponder. This prior art calls for the inclusion of label printer hardware and related consumable materials that are not necessary for many RFID applications. Unneeded printer mechanisms create unnecessary complexities, size, and weight. In some instances this additional bulk hinders practical mobile applications. The result is that tagging solutions that include printing result in a higher total cost of ownership than a pure RF tag encoding system.

United States Patent Application No. 2003/0227528 by Hohberger et al. published on 11 Dec. 2003 describes another attempt at improving demand-print labels by providing a device that combines two standard, die-cut rolls of media, one of which may be a roll of RFID transponders, and the second, print-label stock, in an attempt to provide on-demand smart labels. As with the aforementioned references, this approach adds unnecessary cost and complexity by combining RFID transponders with demand-printed labels.

U.S. Pat. No. 5,382,784 by Noel H. Eberhardt issued on Jan. 17, 1995 describes a hand-held dual technology identification tag reading head with a gun-shaped housing and a trigger switch with two different ON positions. This patent discloses a hand-held device with a light transmissive window at one end, through which bar code scanning light passes and around which an RFID reading antenna is positioned. Eberhardt discloses embodiments for reading either bar code or RFID information from a label using a hand-held, dual-position trigger actuated device. This patent fails to offer any methods or devices for reading bar code information and using that information to encode an RFID tag. In particular this patent fails to disclose any methods for conveyance of RFID tags as part of a well-controlled tag encoding process.

U.S. Pat. No. 6,486,780 by Sharon R. Garber et al issued on Nov. 26, 2002 discloses a hand-held item location device using RFID to seek and find library books. The disclosure emphasizes the importance of read range over great distances and large populations of RFID tags, a quality that runs counter to the present invention that teaches how to localize radio frequency fields for programming only selected RFID tags presented in succession for well-controlled encoding. Garber teaches techniques for searching and reading large collections of tags in a library, not semi-automated tag commissioning processes. The physics of Garber's invention is poorly suited to programming anything other than one tag at a time that is carefully isolated by great distances from any other RFID tag to avoid programming information into the wrong tag.

U.S. Pat. No. 5,280,159 by Darald R. Schulz et al. issued on Jan. 18, 1994 discloses a pistol-grip RFID reader with a separate hand-held data terminal which together are used to read RFID tags. Again this invention, like other prior art fails to teach a viable method or apparatus for reliable commissioning large volumes of RFID tags.

Douglas Walter Main and Tim A. Kassens disclose, in U.S. Pat. No. 5,763,867 issued on Jun. 9, 1998, a hand-held data terminal with various scanner modules for the purpose of data acquisition. This patent, along with there subsequent and related disclosure in U.S. Pat. No. 5,962,837 issued on Oct. 5, 1999, are examples of hand-held data collection devices for sweeping an RFID interrogation beam about an broad area around an operator (for example, a storage room or bulk-shelf location in a warehouse) This operating distance, however, lies beyond a close-range distance of a couple of inches and is limited to interrogation and data-acquisition, not encoding. Further, such devices are unable to limit their communication to RFID tags that are in close-proximity of a few inches of the operator holding a hand-held encoder that includes a near field coupler.

Curt L. Carrender, Jeremy A. Landt, and Donald F. Speirs disclose in their Dec. 15, 1998 U.S. Pat. No. 5,850,187 another RFID reader that is designed “to allow for identification of objects at locations removed from the remote host unit”. This, along with their Jun. 20, 2000 U.S. Pat. No. 6,078,251, “retrieve object identification data from a selected object.” However, these disclosures fail to address controlling the inherently propagative nature of the electric fields of radio waves in order to restrict their range to within the width of a single tag.

U.S. Pat. No. 6,195,053 issued to Kodukula and Ackley on 27 Feb. 2001 discloses an antenna consisting of a U-shaped conductive bracket, supports an optical reader and communicates with RFID transponders. However, this disclosure does not address the need for shielding and near-field coupler design to optimize the inherent long-range characteristics of the RFID tag.

Helton and Wiklof's Mar. 19, 2002 U.S. Pat. No. 6,357,662 discloses a device that a user can selectively control a bar code scanner and an RFID reader to acquire information about an asset. However, this disclosure does not address creating and encoding a unique identifier for attachment to and subsequent identification of the asset.

So, despite recent advances in RFID technology, the state-of-the-art does not fully address the needs of efficient, economical, high-volume, cost-effective, reliable deployment and commissioning of RFID transponders and wireless sensors. And, large-scale adoption and deployment of RFID transponders depends on systems utilizing reliable, low-cost transponders and efficient commissioning means. Such systems should further include compliance with Gen2 EPC specifications or ISO standards, enable standards-based wireless connectivity, provide various levels of tag and encoder security, efficient replenishment of programmable transponder supplies, and enable secure software re-programming to adapt to future demands and improvements.

### SUMMARY OF THE INVENTION

The present invention overcomes the shortcomings of the prior-art attempts and, accordingly, provides systems, methods, and devices that commission RFID transponders on-demand and at a point-of-use utilizing wireless data transfer in a compact package that is well-suited to portable, mobile, or fixed use in multiple applications. Further advantages of the present invention will be well-appreciated by those skilled in the art upon reading this disclosure including the appended figures of the drawing.

In one preferred embodiment, an RFID transponder adapted for use in an RFID encoder, comprises:

a transport liner substrate layer adapted to selectively peel away from a pressure-sensitive adhesive layer when sufficient tension is provided around a peel-device to enable extraction of the RFID transponder from a protective enclosure; and

an RFID inlay comprising an antenna structure coupled to an RFID chip, the RFID inlay coupled to the adhesive layer; and

a layer of planar material folded along an axis parallel to the major axis of the inlay portion of the transponder; and

a shape memory characteristic within the folded layer sufficient to form an angular bend when external compression forces have been removed; and

a means for the inlay portion of the transponder to spatially separate from a surface to which the adhesive layer has bonded.

This RFID transponder further comprises a visual-marking layer for enabling machine or human visual recognition of a bar code or other visual marking scheme.

In another preferred embodiment, the present invention includes a method for tagging a container comprising:

providing an encoder having at least one RFID transponder;

identifying information to be encoded on the RFID transponder;

commissioning the RFID transponder by encoding the information;

presenting the RFID transponder for attachment to the container by pulling a conveyance web or a release liner with transponder attached thereto around a peel-device to extract transponders from a protective enclosure.

In yet another preferred embodiment of the present invention another method for commissioning RFID transponders comprises:

providing an RFID transponder encoder having a peel-device;

providing information to the encoder;

providing a protective enclosure containing at least one of the RFID transponders;

coupling the protective enclosure to the encoder;

advancing the RFID transponder in the encoder; and

checking the RFID transponder for authenticity; and

encoding the information into the transponder.

Additionally, this method further comprises: Halting transponder encoding if transponders lack proper authentication; applying the RFID transponder to a target surface if the information was properly encoded; storing the RFID transponder if the information was not properly encoded; providing the encoder with a motor adapted to provide tension in the conveyance web or release liner in a direction along its major axis.

In yet another preferred embodiment, the present invention includes a method for recycling or reusing RFID transponder cartridges comprising:

providing a cartridge coupled to an encoder;

de-coupling the cartridge from the encoder;

removing any unused or un-commissioned RFID transponders and transport web from the cartridge; and

separating constituent components of the cartridge into separate recycle or reuse waste streams.

### DRAWINGS

FIG. 1 is a block diagram of the system and environment according to one embodiment of the present invention.

FIG. 2 is a top view of a possible RFID transponder according to one embodiment of the present invention.

FIG. 3 is a chart showing possible layers of an RFID transponder according to one embodiment of the present invention.

FIG. 3A is a schematic end-view of a bent RFID transponder according to one embodiment of the present invention.

FIG. 4 is a side view of a hand-held mobile encoder with a small tag cartridge according to another embodiment of the present invention.

FIG. 5 is a side view of a hand-held mobile encoder with a large tag cartridge according to yet another embodiment of the present invention.

FIG. 6 is a side view of a desk top mobile encoder according to another embodiment of the present invention.

FIG. 7 is a diagrammatic view of tag cartridges nested and packed for shipping according to one embodiment of the present invention.

FIG. 8 is a side view of a hand-held mobile encoder with a tag wiper blade according to one embodiment of the present invention.

FIG. 9 is a side view of a hand-held mobile encoder with a tamp roller according to one embodiment of the present invention.

FIG. 10 is a flow chart of a method according to another embodiment of the present invention the present invention.

### DESCRIPTION OF THE INVENTION

Making reference to various figures of the drawing, possible embodiments of the present invention are described and those skilled in the art will understand that alternative configurations and combinations of components may be substituted without subtracting from the invention. Also, in some figures certain components are omitted to more clearly illustrate the invention. In some figures similar features share common reference numbers.

To clarify certain aspects of the present invention, certain preferred embodiments are described in a possible environment—as identification means for containers. In these instances, certain methods make reference to containers such as loaded pallets, paperboard boxes, corrugated cartons, pharmaceutical containers, and conveyable cases, but other containers may be used by these methods. Certain embodiments of the present invention are directed for use with commercial corrugated shipping cartons, tagged pallet-loads of shrink-wrapped cases, consumer-goods packaging, consumer goods, or other methods of identifying objects using RFID transponders or wireless sensors, or both.

Some terms are used interchangeably as a convenience and, accordingly, are not intended as a limitation. For example, transponders are used interchangeably with the term tags and the term inlay is used interchangeably with inlet. This document generally uses the term tag or RF Tag to refer to passive transponders, which do not include a battery, but include an antenna structure coupled to an RFID chip which are generally a thin and flat and substantially co-planar and located on a substrate. One common type of passive transponder further includes a pressure-sensitive adhesive backing positioned opposite an inlay carrier layer. However, certain aspects of the present invention work equally well with active transponders. A third type: a battery-assist tag is a hybrid RFID transponder that uses a battery to power the RFID chip and a backscatter return link to the interrogator. Further, this document uses programmable RFID transponders interchangeably with RFID transponders. Programmable transponders enable data to be written or stored more than once.

Suitable environments or applications for certain aspects of the present invention include: Traditional conveyor line or other high-speed machinery with automated transponder printing, encoding, and attachment; Hand attachment of transponders (a method that often is referred to as “slap and ship”; and a novel category of mobile transponder encoders as will be more fully described herein.

The systems, methods, and devices of the present invention utilize an RFID transponder or wireless sensors as a component. Certain RFID transponders and wireless sensors operate at Low Frequencies (LF), High Frequencies (HF) and Ultra High Frequencies (UHF). LF has wavelengths in the 100 to 500 kilohertz range. HF is the band of the electromagnetic spectrum that is centered around 13.56 MHz. UHF for RFID applications spans from about 860 MHz to 960 MHz. Transponders and tags responsive to these frequency bands generally have some form of antenna. For LF or HF there is typically an inductive loop. For UHF there is often an inductive element and one or more dipoles in their antenna structure. Such RFID transponders and wireless sensors utilize any range of possible modulation schemes including amplitude modulation, amplitude shift keying (ASK), double-sideband ASK, phase-shift keying, phase-reversal ASK, frequency-shift keying (FSK), time-division multiplexing (TDM), or Ultra Wide Band (UWB) method of transmitting radio pulses across a very wide spectrum of frequencies spanning several gigahertz of bandwidth. Modulation techniques may also include the use of Orthogonal Frequency Division Multiplexing (OFDM) to derive superior data encoding and data recovery from low power radio signals. OFDM and UWB provide a robust radio link in RF noisy or multi-path environments and improved performance through and around RF absorbing or reflecting materials compared to narrowband, spread spectrum, or frequency-hopping radio systems. Wireless sensors are reused according to certain methods disclosed herein. UWB wireless sensors may be combined with narrowband, spread spectrum, or frequency-hopping inlays or wireless sensors.

A. System Overview

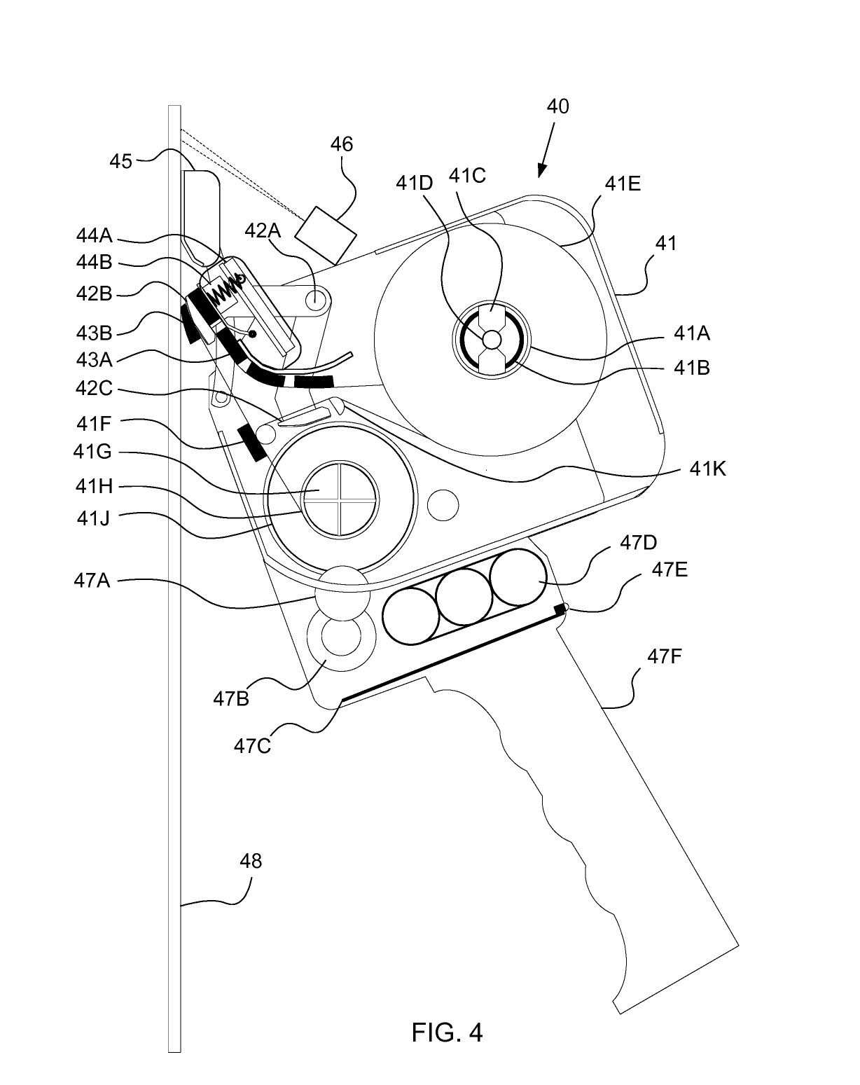

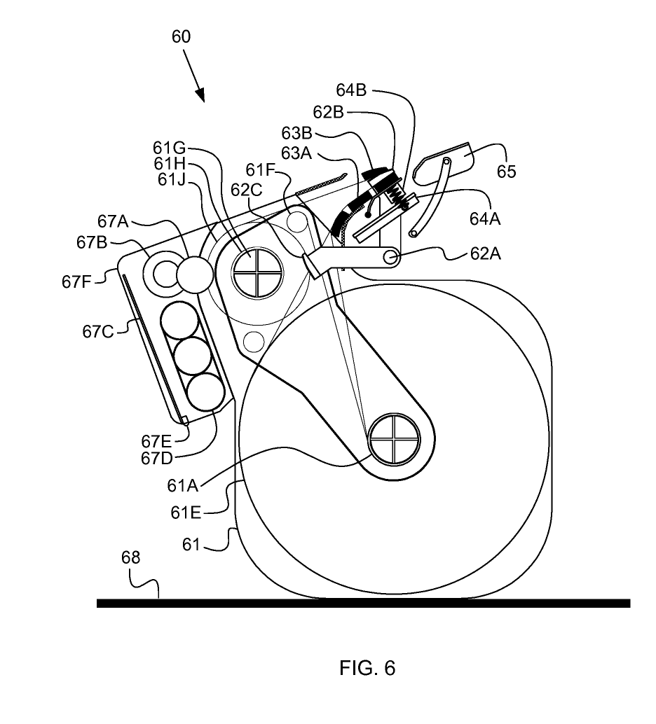

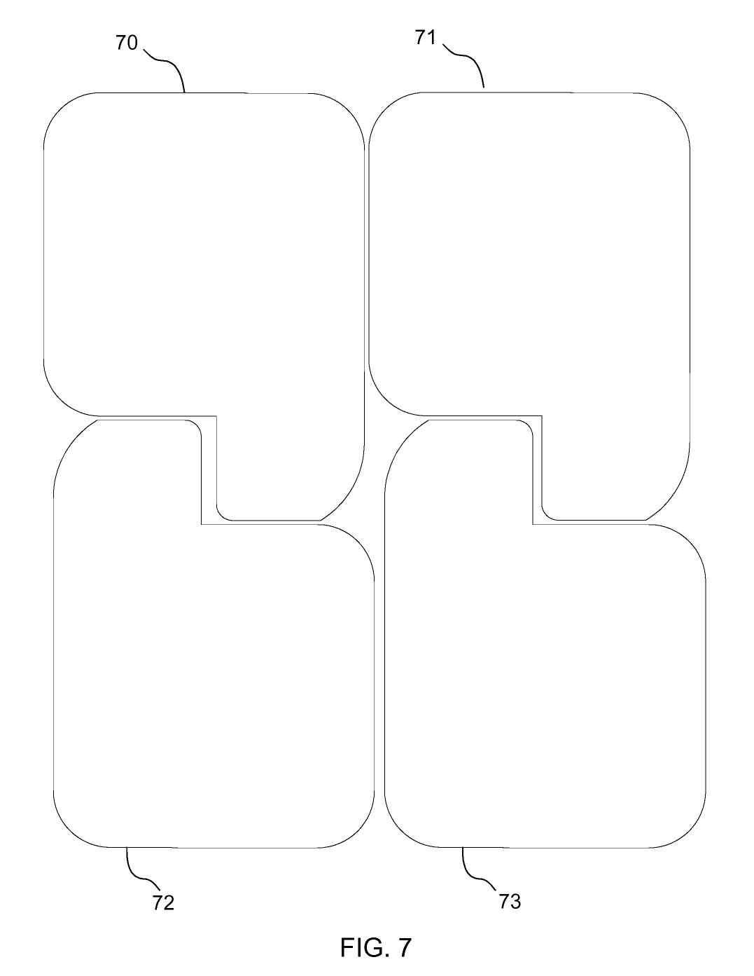

The present invention includes a system for commissioning wireless sensors at a point of use and on-demand. For example, in one preferred embodiment, the present invention incorporates a mobile encoder device 15, which may be held in the hand of an operator and powered by rechargeable batteries. The mobile encoder 15 (also depicted by reference numerals 40, 50, 60, 80, and 90 in FIGS. 4, 5, 6, 8, and 9, respectively) is preferably in wireless communication with a remotely located mobile computer 12 or a host computer 11. The operator can selectively (on-demand) enable the mobile encoder 15 to commission a transponder based on various criteria, including input decoded from printed symbols received through an integrated optical reader 14 or optical reader 13 associated with remote computer 12 for example.

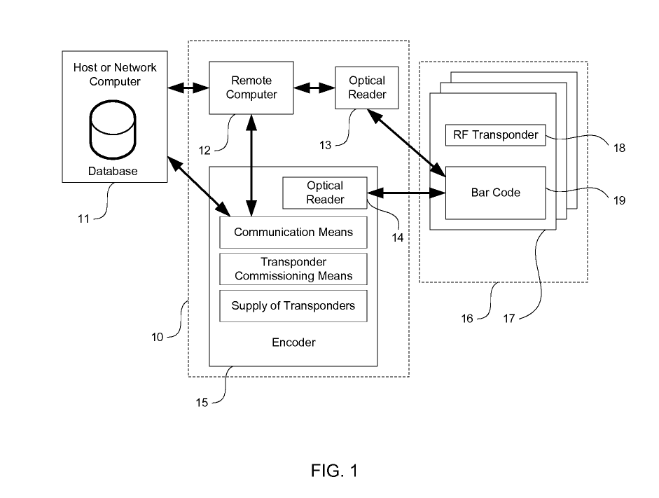

FIG. 1 shows one system 10 according to the present invention in a typical environment, such as a packaging or distribution facility wherein a collection 16 of entities 17 with visual external labels 19 exist and a sub-set (or all entities) need to be associated with a wireless RFID transponder, tag, or label 18. The object 17 needing an RFID transponder 18 could be a packing container. As entities 17 are pulled from the collection, a traditional optical reader 13 or integrated optical reader 14 interprets the human readable or machine readable symbols printed on visual external label 19. A preferred embodiment of bar code scanner 14 is shown as optical scanner 46 (as shown in FIG. 4, for example) with a field of view directed onto the target object as shown in FIG. 4. Information from the external, visual label 19 is correlated to information stored in a centralized location, represented by a network computer 11 having a database. The information derived from the optical reader 13 or integrated optical reader 14 is used by mobile encoder 15 (also referred to as encoder 40, 50, 60, 80, 90 in FIGS. 4, 5, 6, 8, and 9, respectively) to either directly or indirectly encode data into RF transponder 18 while it is still physically within mobile encoder 15. In a preferred embodiment a backup bar code is printed as symbol 19 on entity 17 in a manufacturing facility or other suitable location. Such bar codes are described in ISO/IEC draft document PDTR 24729-1, in which Chapters 11 through 15 detail various methods of encoding EPC data structures into linear and two-dimensional bar codes. A preferred method of tag commissioning with mobile encoder 15 is to use optical reader 14 to read and decode backup bar code symbol 19 to completely specify data that is to be encoded into what will become RF transponder 18. This preferred method will then operate in what is commonly referred to as batch or stand alone mode, whereby utilizing intermittent connections with either remote computer 12 or host computer 11. This preferred method allows existing label printing hardware located on existing manufacturing lines to print all data that would be encoded into an RF transponder without having to incur either the cost of that transponder or the special equipment that is required to encode and apply RF transponders.

The system 10 includes at least three possible sets of wireless connection paths between the following entities if they are present and connected at any point in time within system 10. The first entity is mobile encoder 15 which is the foundation of system 10. The second entity is an optional remote computer 12 which may be intermittently connected or not all. The third entity is host computer 11 which may also be intermittently connected, or may possibly be housed at a remotely located facility that may optionally be accessed over a large distance. Remote computer 12, host computer 11, and the mobile encoder 15 may be connected either directly or through a common wireless access point. A preferred short range wireless connection such as a PAN (Personal Area Network) may be established from time to time between mobile encoder 15 and remote computer 12. There is a preference for low power wireless connection apparatus within mobile encoder 15 so as to realize the greatest possible battery life in a light weight hand held mobile encoder 15. In these aforementioned embodiments, the mobile encoder 15 is a portable device that can be easily carried by a human operator. As such, the mobile encoder 15 includes an internal power source such as a rechargeable lithium-ion battery and would further include a handle for ease of use. Further details of possible configurations of the mobile encoder will be further detailed in subsequent sections of this disclosure.

In the system 10 of FIG. 1, the mobile encoder 15 carries a supply of un-commissioned, blank, or securely encodable RFID transponders. Once the desired data is accumulated by mobile encoder 15 it advances the tag commissioning process by encoding an RFID transponder, creating an RFID tag or label 18 for the object 17. The commissioned tag or label 18 can then be applied, linked, or otherwise associated with the object by known means including a human operator or a machine transfer as will be further described in this disclosure.

B. RFID Transponders

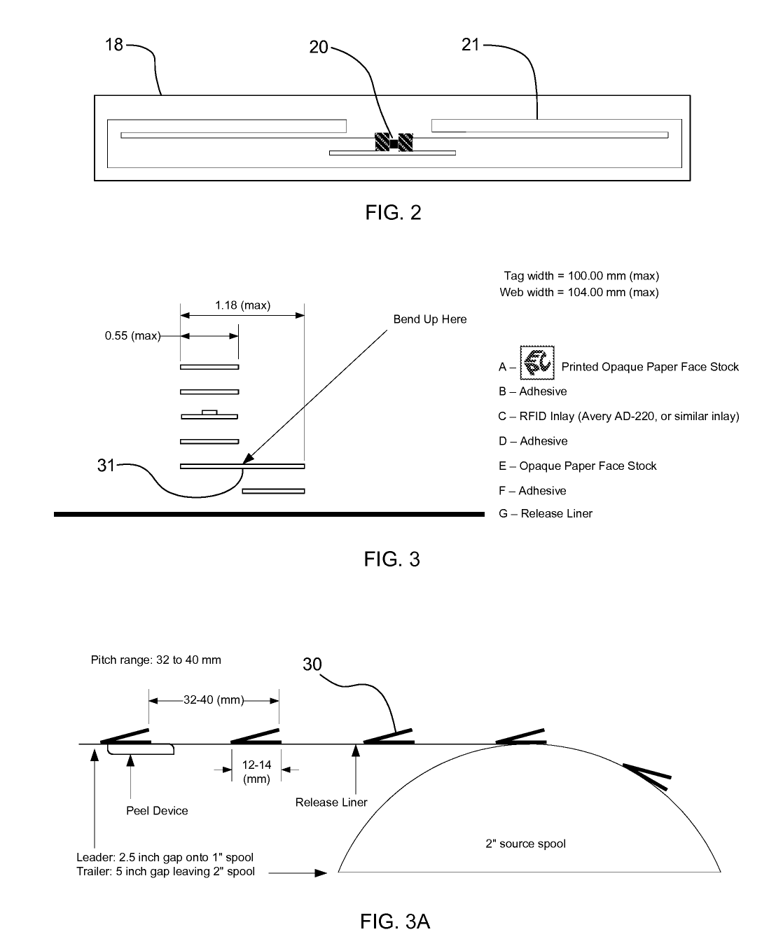

FIG. 2 shows a possible RFID transponder 18. RFID transponders, essentially, comprise an RFID integrated circuit (IC) device (or “chip”) 20 bonded to an antenna apparatus 21, formed on a substrate that is often plastic such as Mylar (a registered trademark of E. I. Du Pont De Nemours and Company Corporation of Wilmington Del., polyester, or PET. One way to form an antenna structure is to etch copper from a substrate. An alternate way includes printing multiple layers of conductive ink onto a substrate. One additional method includes stamping UHF antennae from thin sheets of aluminum or by selective aluminum deposition onto a substrate. In certain embodiments, RFID transponders and wireless sensors are recovered from waste streams for reconditioning, reprogramming, and reuse.

Other suitable RFID transponders include designs that combine a dielectric spacer behind the antenna to create a transponder that performs well over a broad range of packaging conditions. A robust design also includes features to protect the transponder from mechanical or ESD damage.

FIG. 3, a chart showing a preferred construction for an RFID tag according to one embodiment of the present invention, shows a material stack specification for a bent tag with sufficient shape memory to pop up after attachment to a target surface. The purpose for popping up is to provide an air dielectric gap between the antenna and any surrounding metals or liquids.

FIG. 3A shows a preferred tag design for tagging RF-challenged materials that involve nearby metals or liquids. This tag design is an improvement over the Flag Tag design disclosed by Sato America, Inc. of Charlotte, N.C. Bent tag 30 of FIG. 3A results in a tag that can be applied to a surface and have a portion of the tag stick out in a direction that is roughly perpendicular or normal to that surface. This is achieved through the shape memory of the opaque face stock of layer E shown in FIG. 3A. The bent tags 30 are bent at fold 31. The folding operations are preferably performed by automated equipment on the tag converter manufacturing line. Bent tags 30 remain folded back against themselves when inside the cartridge. This configuration dramatically reduces the amount of space required for storing and transporting unused tags.

In certain embodiments, the RFID transponder is programmable and mechanically configured for tensile extraction from a protective enclosure.

In one preferred embodiment, additional transponder layers include a thin and flexible energy cell comprising two non-toxic, widely-available commodities: zinc and manganese dioxide. One suitable energy cell is developed by Power Paper Ltd. of 21 Yegia Kapayim Street, Kiryat Arye, Petah Tikva, P.O.B. 3353, ISRAEL 49130, and incorporates an innovative process that enables the printing of caseless, thin, flexible and environment-friendly energy cells on a polymer film substrate, by means of a simple mass-printing technology and proprietary inks. The cathode and anode layers are fabricated from proprietary ink-like materials that can be printed onto virtually any substrate, including specialty papers. The cathode and anode are produced as different mixes of ink, so that the combination of the two creates a 1.5-volt battery that is thin and flexible. Unlike conventional batteries, this type of power source does not require casing.

A top layer of an RFID transponder assembly comprises a paper face-stock, which is a very low-cost material but also is the least environmentally resilient. UV-resistant plastic face-stock generally provide the best survivability in outdoor and rough-service environments, and also provide the best protection for the RFID transponder assembly.

A bottom layer of pressure-sensitive adhesive (PSA) often is used for attachment of transponders to objects and often is referred to as a wet inlay or a wet tag or a wet transponder.

C. Mobile Encoder

FIG. 1 shows a system 10 according to one preferred embodiment of the present invention including a mobile encoder 15 (also referred to as encoder 40, 50, 60, 80, 90 in FIGS. 4, 5, 6, 8, and 9, respectively). FIGS. 4, 5, 6, 9, and 9 detail possible mobile encoder 15 configurations. In these embodiments, the encoder is held in a hand of an operator. An antenna and wireless subsystem supports wireless connectivity to a host or network computer 11 or, to a remote-computer device such as a PDA, PDT, or a wrist-mounted terminal such as the HX2 that is available from LXE of Norcross, Ga. In a preferred embodiment the LXE HX2 or similar device is used with optical reader 13 which is a ring scanner that is finger-mounted and reads bar codes.

There are several methods of transferring an encoded RF transponder from the transport media (such as release liner) onto a target surface (such as a corrugated carton). One preferred embodiment uses a thumper mechanism to simultaneously detach an encoded transponder off of the transport web and thrust it along a vector that is normal to the surface of the target object. The primary disadvantage of this method is that a second motor or linear actuator or solenoid is required; consuming more power, space, and weight. Another disadvantage is that sensors are required to assure that the mobile encoder is within range of the operating stroke range of the thumper. Otherwise the target surface is likely to be too far from the transport web to complete a proper transfer. In other extreme cases the thumper may strike the target surface with too much force, possibly causing damage to the target surface. This can be of particular concern if the target surface is made of glass or another fragile or precious material or surface finish.

In another embodiment, the encoded transponder is handled by a rotating tag transfer head that is temporarily in contact with the adhesive face of the tag. As the rotating head carries the encoded tag along a circular path, the larger exposed portion of the tag's adhesive will come into contact with the face of the target surface, forming an adhesive bond that soon exceeds the strength of the temporary adhesive bond that is holding the tag to the rotating head. The tag will then completely peel away from the rotating tag transfer head onto the target surface. A primary disadvantage of the rotating tag transfer head method is that again another electromechanical device, in this case a gear motor is likely required to power the rotating head; resulting in more cost, weight, and bulk.

In another set of preferred embodiments, the human operator becomes part of the tag transfer system. Handheld labeling devices such as the prior art Towa AP65-100 handheld label applicator sold by Raco Industries, are designed for the operator to assist with the tag peeling process by moving the device across the target surface, cooperative with the tag peeling from the release liner. However it is well known that such devices involve a high degree of eye, hand, and arm coordination that leave process control quality to chance. The result of an uncontrolled tag application process is damaged tags and inconsistent quality. The preferred embodiments shown in FIGS. 4, 5, 6, 8, and 9 address these short comings to varying degrees. These embodiments which are disclosed herein with are used by moving, dragging, or wiping the encoder across the target surface while at the same time the encoded tag detaches from release liner and transfers directly along a vector that is nearly parallel with or tangent to the target surface without a thumper, rotating transfer head, or other intermediate device.

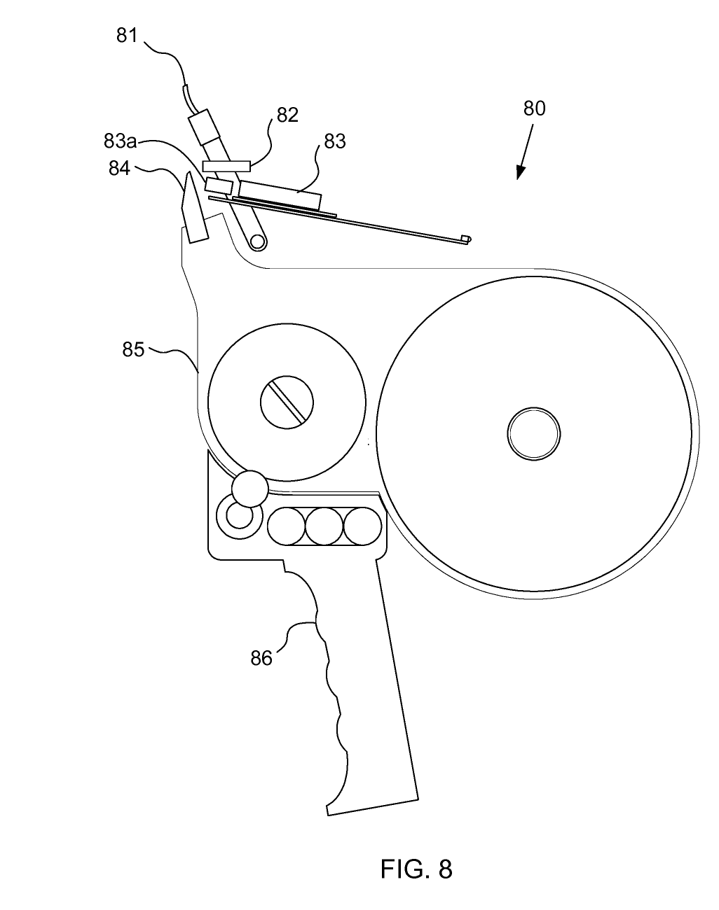

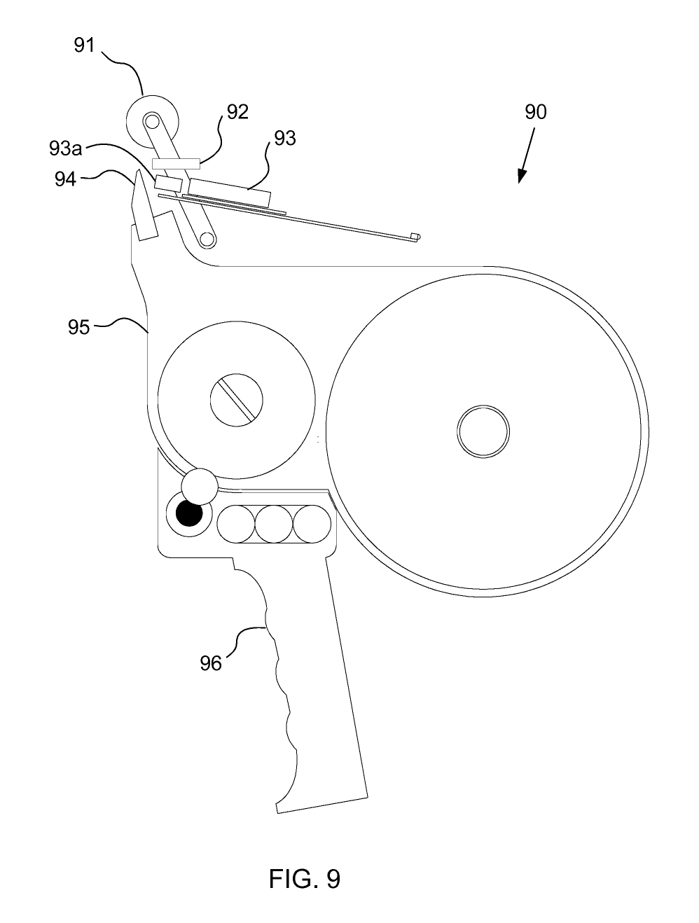

FIG. 8 shows another preferred embodiment of an encoder 80 according to the present invention. As such, the encoder 80 includes a handle 86 adapted to enable a user to hold and manipulate the encoder for wireless or other uses during commissioning or reading RFID tags. This encoder 80 uses a wiper 81 to apply pressure on an applied tag, against the target surface when encoder 80 dispenses and subsequently adheres it to a target surface. Either thin or thick foam-backed tags are encoded and tested with RFID Interrogator 83 and the associated near field coupler 83a, both part of an assembly mounted on one or more printed circuit boards. Sensor 82 is in certain preferred embodiments an optical sensor with a short focal length to detect the arrival and departure of tags as they pass over the distal end of peel device 84. Cartridge 85 is used to load a fresh supply of tags into encoder 80 and as a means for removal of spent release liner.

Near field coupler 83a is preferably responsive to RFID tag antenna structures that come into very close proximity to it, changing impedance to become a closer match to the output impedance of RFID interrogator 83. The result is that the tag becomes inductively coupled with near field coupler 83a which is normally in a detuned state when no RFID tags are near it. In certain preferred embodiments, near field coupler 83a is formed using a coil of wire, mounted to an impedance-controlled microstrip conductor, which is backed and surrounded by a ground plane. The operation of this unique near field coupler, its design, and benefits is more comprehensively discussed in this applicant's co-pending U.S. utility patent application Ser. No. 11/767,471 filed on 22 Jun. 2007, and in applicant's published application number 2007/0125836 published on 7 Jun. 2007, both disclosures are expressly incorporated by reference for all purposes as if set fully out herein.

FIG. 9 shows another preferred encoder 90 according to the present invention. The encoder includes a handle portion 96 and cartridge 95, similar to the encoder 80 of FIG. 8, for example. However, in FIG. 9 roller 91 replaces wiper 81 (of FIG. 8) to accomplish the same tag tamping function. Certain preferred embodiments of the mobile encoder shown in FIG. 9 also include a shaft encoder on roller 91 such that the linear motion of mobile encoder 90 can be tracked across the face of the target surface. Certain preferred embodiments use shaft encoder information to regulate the speed of the motor and the tag transport web to synchronize the tag peeling with the operator's hand and arm motion so that the linear velocity across the target surface is approximated by the linear velocity of the tag emerging from the distal end of tag peel device 94. Optical sensor 92 monitors the arrival of each advancing tag. RFID interrogator 93 and associated near field coupler 93a cryptographically unlocks encodes and verifies each tag one by one as they arrive. Interrogator 93 is preferably an M9 manufactured by SkyeTek of Westminster, Colo. Interrogator 93 may also be of a similar type from another manufacturer such as ThingMagic of Cambridge, Mass. or WJ Communications of San Jose, Calif. Interrogator 93 may be intended for reading and encoding transponders in any or all of the UHF, HF, LF, or microwave frequency bands.

The embodiments shown in FIGS. 4-6 use another preferred method of sensing the linear motion of the mobile encoder (reference numeral 40, 50 and 60 in each FIGS. 4, 5, and 6, respectively) across a target surface by using an optical mouse sensor 45 as is also shown in FIG. 4. Such devices are commonly used to track the hand movements of the operator of a computer. Motion in either the X or Y direction is translated into numerical displacement representations which when timed are converted into linear velocities. Tracking and processing the primary axis of motion parallel to the major axis of the release liner, the web speed is preferably controlled by processor and electromechanical sub-system such that transponder 43A, 53A, or 63A advances at a rate of speed that matches the velocity of the entire mobile encoder across the target surface. Optical mouse 45, 55, or 65 tracks displacement across the target surface and also acts as a tamp head to strengthen the adhesive bond of each freshly applied tag. The process of attachment of the encoded transponder to the target surface is along a vector that is nearly parallel to the target surface at a speed that is based on real time feedback from the surrounding environment as sensed by the optical mouse or other sensor. Optical mouse sensor 45, 55, or 65 preferably illuminates its target surface with either an LED (Light Emitting Diode) or a laser. Avago Technologies of San Jose, Calif. manufactures a variety of mouse sensors, both LED-based and laser-based. Laser illumination provides smooth and accurate motion sensing across a variety of surfaces. The model ADNS-6150 small form factor lens working in conjunction with the ADNS-6530 integrated chip-onboard laser sensor and single-mode vertical-cavity surface emitting laser can be used to not only detect motion in the X and Y directions, but also to some degree in the Z direction. Displacement along the Z (depth) vector is reported by the decrease in the number of resolvable features within the field of view as the target surface fades away from the optical focal point.

Optical mouse sensor 44B, 54B, or 64B is used to measure the linear velocity of tags as they move along the path of the release liner toward peel device 42B, 52B, or 62B, as well as sense the gaps and edges between tags 43A, 53A, or 63A and those adjacent to them. The angular velocity of motor 47B, 57B, or 67B is controlled to achieve a linear tag velocity that matches the velocity across the target surface. Therefore an operator with a fast hand motion is just as successful as a person with a slower hand motion, both will result in a tag that lays flat, co-planar with the target surface, void of kinks or wrinkles that are characteristic of a poorly controlled tag application process. In either case, tag dispensing by electromechanical subsystem will not initiate until optical mouse sensor 45, 55, or 65 preferably illuminates the target surface and detects a minimum number of valid features as reported by the SQUAL register.

RFID Interrogator 44A, 54A, or 64A encode RF transponders using LF (Low Frequency), HF (High Frequency), UHF (Ultra High Frequency), or microwave radio energy. Transponders may be powered by radio energy, light, or stored energy from a source such as a battery. RF coupling is preferably through a near field coupler, an inductive loop or other suitable transducer to focus RF energy on a small area within the mobile encoder.

The present invention incorporates a careful use of shielding and near field coupler design for strictly localized encoding of a single selected RFID tag to overcome inherent long-range interrogation characteristics of RFID tags. In certain preferred embodiments, shielding is used to prevent unintentional programming of nearby tags, especially tags that are ‘next up’ for programming once the immediate tag has been encoded, verified, and dispensed. These nearby tags are located within the confines of the encoder device itself, on recently placed items, so the scale—relative to the operator—is within an arm's length, or more typically, less than 6-inches from tag currently being encoded. The design, operation, benefits, and use of careful shielding is more comprehensively discussed in this applicant's co-pending U.S. utility patent application Ser. No. 11/767,471 filed on 22 Jun. 2007 and in applicant's published application number 2007/0125836 published on 7 Jun. 2007, both disclosures are expressly incorporated by reference for all purposes as if set fully out herein.

Certain preferred mobile encoder embodiments will not encode RF transponders that fail authenticity tests. In a like manner, RF transponders will preferably not allow themselves to be programmed unless the interrogator can successfully unlock its secured memory banks. This is a preferred method of protecting tag cartridge and mobile encoder supply chains from counterfeits and knock-offs. Mobile encoder 15 (also referred to as encoder 40, 50, 60, 80, 90 in FIGS. 4, 5, 6, 8, and 9, respectively) and the transponders loaded into it will only be successful in exchanging certain data if certain data encryption and challenge response protocols are adhered to. In a preferred embodiment each authorized RFID tag converter company uses one or more encryption keys to generate passwords that lock the RF tags, whereby preventing them from being programmed unless they are unlocked using the same password. Passwords of this type are specified in the EPC Gen 2 specification and in ISO standards. The passwords are preferably generated by a processor using a public key from publicly readable data such as an asset number or a tag serial number. A shared private key is then used by an encryption algorithm such as AES in order to create a password or a collection of passwords that can be used to lock or unlock one or several RF tags. Other methods may be used that provide a high degree of certainty that the both the tags and the mobile encoders are from legitimate sources. Individual failures or patterns of authentication failures are preferably reported to a central database through wireless communications for subsequent fraud investigation.

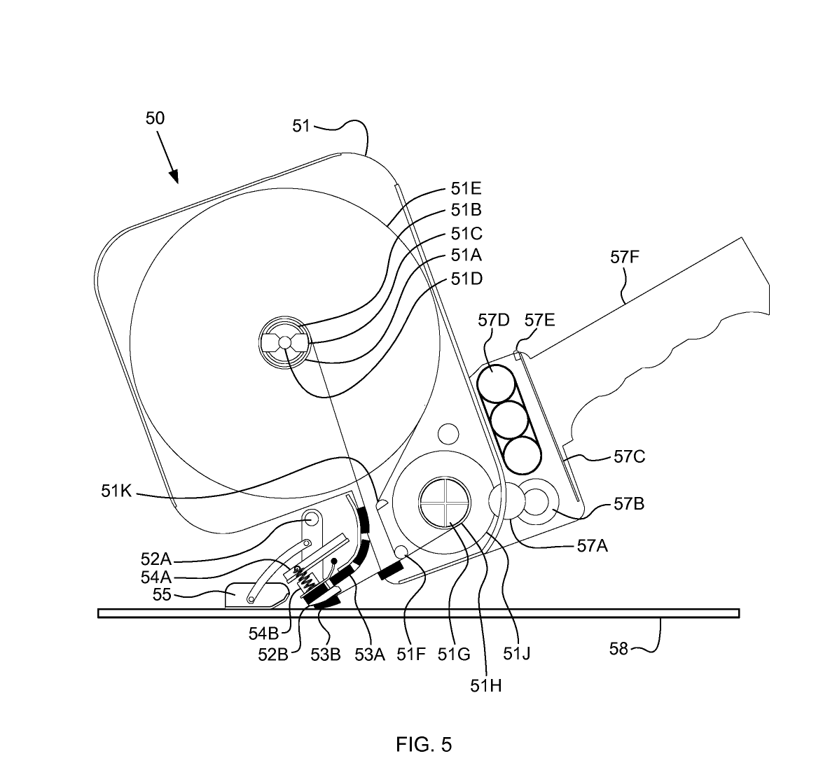

Peel device 42B, 52B, or 62B is part of the mobile encoder and preferably rotates about pivot point 42A, 52A, or 62A into position 42C or 62C and a corresponding position (not shown) in FIG. 5. When cartridge 41, 51, or 61 is inserted into applicator body 47F, 57F, or 67F the web is held in a non-interfering position by guide post 41F, 51F, or 61F and its accompanying cartridge guide post 41K or 51K such that peel device 42C or 62C (which is peel device 62B shown in a retracted position) can self-thread around the transport web without human effort. This is an improvement over prior art where a peel device is an integral part of the cartridge and requires threading during the cartridge assembly process.

Peel device 42B, 52B, or 62B preferably contains a shield on the outer face of the blade, through which radio energy will not pass to encode or interact with a rejected tag 43B, 53B, or 63B. The dielectric material of the peel device 42B, 52B, or 62B provides sufficient separation from a tag within the encoding zone and the shield on the back side of the peel device. This is another advantage over a peel device that is part of the cartridge, where the cost sensitivity is much more acute. The shielding on the back side of peel device 42B, 52B, or 62B may be any suitable metal attached or adhered in any reliable or economical manner against the non-conductive dielectric structure of the peel device.

Rejecting tag 43B, 53B, or 63B requires that mobile encoder tag peel device 42B, 52B, or 62B have sufficient clearance from target surface 48, 58, or 68 as determined by optical mouse sensor 45, 55, 65 using either the SQUAL reading or the shutter readings. Such readings are used to determine if there is sufficient space to advance and rotate a bad tag 43B, 53B, or 63B around the distal end of peel device 42B, 52B, or 62B.

Several operator indicator lights 47E, 57E, and 67E preferably include a system-ready LED, data-ready LED, tag-ready LED, and battery-ready LED on the housing with appropriately positioned light pipes to enable the operator an easy view of the mobile encoder device status.

Also included on the exterior of the housing is an external, power-cord receptacle so that the on-board lithium-ion, nickel metal hydride, or other appropriate battery 47D, 57D, or 67D may be charged as required. An on/off switch enables the operator to selectively power up the encoder. A reset port, such as a recessed reset button enables an operator to reset the device circuitry on control board 47C, 57C, or 67C as may be required.

A cartridge 41, 51, or 61 containing a plurality of RFID transponders releasably mounts to the body of housing 47F, 57F, or 67F. The cartridge further includes a take-up reel 41J, 51J, or 61J for non-dispensed RFID transponders, and a port through which blank or securely encodable transponders emerge from source reel 41E, 51E, or 61E. The source reel is comprised of core 41A, 51A, or 61A which may be made from plastic or a recyclable kraft paper fiber to form a wound tube. A tube extends from the walls of cartridge 41, 51, or 61 to form axle 41B and 51B around which core 41A, 51A, or 61A rotates. Brake shoes 41C and 51C create drag, resulting in back torque on the source core, the magnitude of which is controlled by screw 41D or 51D which with a knob (not shown) is used to adjust the force applied by brake shoes 41C and 51C. The back torque for cartridge 61 is developed through an expandable friction coupling into a brake mechanism attached to encoder body 67F.

Take-up core 41H, 51H, or 61H is driven by a tight coupling between hub 41G, 51G, and 61G. This tight coupling is achieved through a combination or selection of tight fit, expandable coupling, and sharp teeth. The result is a hub that will easily slide in or out of core 41H, 51H, or 61H with little effort, but still be capable of delivering a substantial amount of drive torque through that connection without slippage.

Drive torque is delivered from gear motor 47B, 57B, or 67B to hub 41G, 51G, or 61G through drive gear 47A, 57A, or 67A the teeth of which engage with each other as cartridge 41, 51, or 61 is set into position and locked into place.

In the aforementioned embodiments of the mobile encoder 15 (also referred to as encoder 40, 50, 60, 80, 90 in FIGS. 4, 5, 6, 8, and 9, respectively), various sizes of cartridges and transponder types are accommodated by a common engagement to encoder body 47, 57, or 67; sharing common geometry and interface specifications. The result is a family of interchangeable cartridges and encoders. FIG. 7 illustrates a preferred method of packing multiple cartridges 70, 71, 72, and 73 into a shipping container to realize the maximum packing density for full cartridges.

Cartridges 41, 51, and 61 preferably disassemble for easy recycling. For example, end users may choose to reduce their shipping costs for the recycling of cartridges and release liner by separating them into different recycle waste streams at the point of use. Conversely cartridges 41, 51, and 61 are manufactured and assembled by snapping together the mating components with latches, guide pins, slots, and other such features to mechanically secure themselves into a rugged structure, capable of tolerating the abuse that is common for shipping and handling. After each use, cartridges 41, 51, and 61 are preferably disassembled such that similar parts of like cartridges all nest within each other to form a dense stack. Each stack can then be accumulated and shipped either together or separately back to a tag recycling facility. The spent release liner and any rejected tags may also be accumulated separately and may optionally be sent to a different preferred waste processing facility, possibly in order to reduce shipping costs. One such facility preferably has the ability to reprocess release liner that is not comprised of silicone. Certain silicone alternatives include emulsion release coatings that are water-based coatings that offer similar performance to hydrocarbon solvent-based release liner products. Emulsion coatings are compatible with paper repulping processes and are highly preferred. The benefits of the silicone alternative coatings are not normally available to the RFID tagging work flows because one cannot visually identify an environmentally friendly coating from one that is not. Therefore, by controlling both the composition of the outbound materials as well as the inbound recycling processes, this cartridge-based method of tag encoding offers real promise for reducing stress on the environment.

In the aforementioned embodiments of the mobile encoder 15 (also referred to as encoder 40, 50, 60, 80, 90 in FIGS. 4, 5, 6, 8, and 9, respectively), key features commonly shared include means to enable Gen2 EPC or ISO standards compliance and printer-emulation modes. An on-board power source, such as a rechargeable lithium-ion, Nickel Metal Hydride, or other battery enables freedom of movement. Mobility is further afforded by means for wireless connectivity to a data network, such as the 802.11 wireless LAN (Wi-Fi), Bluetooth, CDMA, or other standards-based long or short range communications protocol. However, a conventional power source that requires connectivity to a power-grid and a cable-based data network connectivity link would work under certain circumstances.

Further, in contemplated embodiments, the fixed or mobile encoder enables selective mounting of a magazine or cartridge filled with un-commissioned RFID transponders, which facilitates rapid and easy loading of the encoder with ready-to-use RFID transponders and further enables re-use, re-commissioning, and recycling of un-dispensed transponders and the associated cartridge. The mobile encoder can be monitored and controlled by virtually any handheld or mobile device, a host computer in a central location, or over the Internet.

The mobile encoder 15 (also referred to as encoder 40, 50, 60, 80, 90 in FIGS. 4, 5, 6, 8, and 9, respectively) is activated (turned on) when an operator selectively depresses the combination on/off switch. Pushing the on/off switch, possibly in conjunction with a second switch for about three seconds or longer results in a sleep-mode cycle that can be interrupted by re-pressing the on/off-next switch. In sleep mode the operator indicators will turn off. If active, the mobile encoder system-ready LED illuminates and connects to the assigned network. Network connectivity may result in the illumination of both the system-ready LED and the data-ready LED. The encoder optionally receives commands and data via the wireless link from the remote computer 12 or host network computer 11 (of FIG. 1). The data represents information to be encoded on an RFID transponder. The information is stored in the encoder's on-board memory and the tag-ready LED rapidly blinks green (cycles on/off to pulsate). An RFID transponder is moved from within the cartridge 41, 51, 61, 85, or 95 to a position near the distal edge of the peel device for encoding in the encoder and the transponder is encoded with the appropriate information. The transponder is tested, and if it contains the correct data and the encoding was successful then all three indicator LEDs indicate a solid-green color. The encoded RFID transponder is then ready to be adhered onto the container of interest when the mobile encoder is wiped by the operator across the target surface, or in the case of a desktop model, when an operator wipes her finger across the face of optical mouse sensor 65. In the case of RF tags being directly transferred onto a user's finger, the tag could then be adhered to a target surface.

In the event that the encoding process failed, the bad transponder is detected and retained by the encoder, where it remains on the take up reel 41J, 51J, or 61J inside the cartridge 41, 51, 61, 85, or 95. The take up reel also collects the release liner as the encoder 15 dispenses good transponders (properly encoded RFID transponders). The take up roll returns to a recycling center where components are reused or recycled as necessitated. Further, the recycling center can perform failure analysis on returned transponders.

Certain protective enclosures, such as cartridges or magazines 41, 51, 61, 85, and 95, are part of a family of interchangeable magazines of similar size, shape, and functionality, which are capable of housing and dispensing certain types, styles, shapes, and sizes of new or used RFID transponders. Large cartridge 51 is intended to hold about 285 4 mm-thick foam-backed tags measuring 12 mm wide. Small cartridge 41 is intended to hold 1000 regular thin tags 15 mm wide on 19 mm pitch.

In at least one preferred embodiment, the magazine or cartridge includes a unique and embedded, RFID transponder which enables automatic interrogation and tracking of cartridge 41, 51, 61, 85, and 95. In certain embodiments, to minimize interference, the cartridge-specific and unique RFID transponder or RFID transponder operates in a frequency band that is different than the supply RFID transponder contained within the protective enclosure. Alternatively, other embodiments selectively interrogate cartridge identification transponders that operate in the same band as transponders within the cartridge that are to be applied.

Certain encoders require replenishment of the battery or other internal, on-board power source, such as a fuel cell, or other energy storage technology. Accordingly, in some embodiments, an encoder 15 further includes a remote, selectively coupling base unit. The base unit enables a replenishment of magazines or cartridges, provides replaceable power sources, recharges the on-board power source, serves as a communications gateway, and provides a user interface for programming and maintenance of the encoder.

As with all ESD-sensitive equipment, care must be taken to avoid a build-up of damaging electrostatic charges. Accordingly, in certain embodiments charge is removed using a variety of conduction methods including wiping or use of special materials that contain short conductive elements optionally arranged within a flexible elastic cord.

In some embodiments, the encoder adapts to use a particular type of RFID transponder. One type of suitable RFID transponder is model number AD-220 from Avery Dennison of Brea, Calif., or Raflatac model 300846 from Tampere, Finland, or a Spider tag or FT-33 FAT tag from RSI ID Technologies of Chula Vista, Calif. Such a transponder is die cut and adhered to release liner. Additionally, wireless sensors are manufactured to specifications that are compatible with the specific encoder, including such specifications as core diameter, outer diameter, and web width. Alternatively, certain steps are required to prepare a standard roll of tags for use in an automated encoder, including unrolling from a large roll (up to about 6-inches in core diameter) onto several smaller rolls having a smaller core diameter (of about 1-inch to about 2-inches in core diameter).

For certain encoder embodiments passwords are encoded into transponders or wireless sensors when they are commissioned. Passwords are used to lock certain memory blocks. Passwords are safeguarded using cloaking, obfuscation, cryptographic techniques, secure and trusted channels, locked memory, and other methods that are commonly used to protect confidential information. Passwords are generated or retrieved from data encoded in an RFID transponder to generate an index into one or more databases that contain a one dimensional array of passwords, a two dimensional array of passwords, a multidimensional array of passwords, or an array of actual or pointers to algorithms used to generate passwords from transponder data, for example. Alternatively, cryptographic algorithms are used generate passwords from transponder data.

Although this disclosure makes specific reference to a mobile encoder, it is understood that the encoder can easily adapt and be readily configured to a fixed operating environment. For example, it can be mounted to a forklift truck or a high-speed conveyer line and maintain advantages of wireless communication, rapid change-over and other qualities as discussed and developed more fully in this disclosure.

D. Method of Tagging Containers

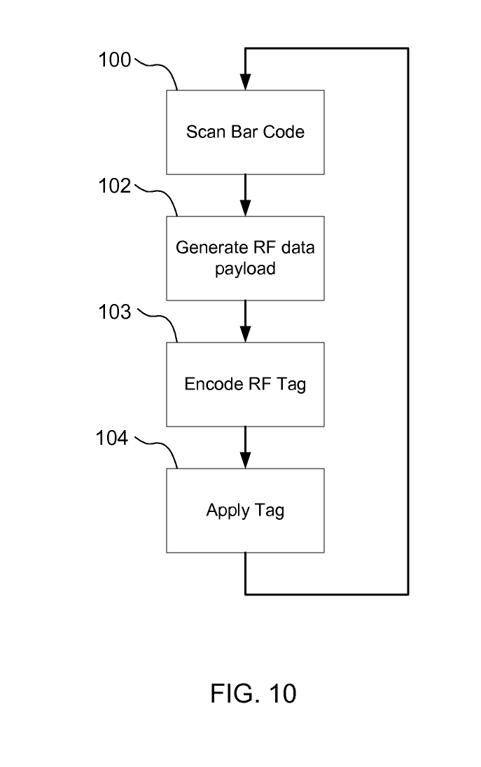

FIG. 10 is a flow chart representing a method according to the present invention including applying RFID transponders to objects of interest. One suitable object of interest comprises transport containers such as corrugated cartons or shrink-wrapped cases on a shipping pallet, which is inadequately addressed by the prior-art, particularly for solutions for manually operated automatic encoding and attachment to a container.

Block 100 represents a process step including the identification and selection of a container to be tagged with an RFID transponder or wireless sensor. In one preferred embodiment this step includes a manual selection and verification processes that consists of manual handling, visual sighting, and scanning bar codes with a hand-held optical reader device. This method contemplates that a transponder encoding scheme is ready in advance and is preferably synchronized with a pick list, customer purchase order, advanced shipping notice, and other such records to assure that goods are properly moved and accounted for.

Block 102 represents the process step of generating the data that is to be encoded into an RF transponder. In this step, bar code data is processed to derive the underlying data. Depending on the type of bar code, how it is encoded, and its purpose, different processing steps will be used. In preferred embodiments the bar code may contain SKU information, a GTIN, an SGTIN, EPC data structures, a military UID, an SSSC, an asset number, a file identifier, or other such identifying information. In certain preferred embodiments, the bar code (either one or two dimensional) contains a partial or complete description of the data that is to be encoded into the RF transponder. Such bar codes are described in ISO/IEC draft document PDTR 24729-1. Chapters 11 through 15 detail various methods of encoding EPC data structures into linear and two-dimensional bar codes. Using such bar codes does not necessarily require the use of additional data in order to generate RF transponder payload data. Mobile encoder 15 may independently receive and process the RF transponder payload, or communicate with a hand-held PDT or other mobile computer 12 or network computer 11.

Block 103 represents another process step whereby mobile encoder 15 (also referred to as encoder 40, 50, 60, 80, 90 in FIGS. 4, 5, 6, 8, and 9, respectively) encodes an RFID transponder with the information of the previous step (Block 102). Optionally, successful commissioning of the RFID transponder is verified by the encoder. In one preferred embodiment, the encoder tests the next transponder and determines if it is operating within certain predefined specifications including parameters such as activation energy, backscatter signal strength, sensor performance, and other indications of the quality of the transponder. If the encoder determines that the transponder is not likely to result in a successful transponder deployment due to either physical or electronic deficiencies or abnormalities, then the operator is informed and the failed or bad transponder is discarded automatically. Mobile encoder 40, 50, or 60 preferably uses optical mouse sensor 45, 55, or 65 to determine if there is sufficient clearance from the target surface or other object to successfully discard a failed transponder onto take-up reel 41J, 51J, or 61J. If not, then the operator is informed through illumination of one or more LEDs in the operator feedback cluster 47E, 57E, or 67E, and/or an audible sound whereby signaling that additional clearance is required to reject a bad tag.

This step (Block 103) also includes processes to read or determine by dead reckoning the information encoded into certain preprinted optically encoded symbols on the outward facing surface. In certain embodiments the printed information is a machine-readable symbol such as a bar-code symbol. For example, one or more machine-readable symbols such as one-dimensional or two-dimensional bar codes and in certain embodiments, the encoded information is used as a reference to one or more data storage locations. In other embodiments the data storage locations are accessible through a computer network. In some embodiments, the encoded information is a series of sequential numbers

Finally, (Block 104) the operator applies the RFID transponder on the container and, thus, commissions the transponder. In certain embodiments, including mobile encoders 40, 50, 60, 80, or 90 directly apply encoded transponders in a preferred location on a target object. In other embodiments, transponders are applied either directly or indirectly to the interior of a carton, the interior of a car or windshield, a medical device, a physical asset, a file, a bag of court evidence, a retail item.

While the invention has been particularly shown and described with reference to certain embodiments, it will be understood by those skilled in the art that various changes in form and detail may be made without departing from the spirit and scope of the invention.

I claim:

1. An encoder for commissioning RFID transponders, the encoder comprising:
an RFID interrogator adapted to enable encoding data according to an encoding algorithm and communicating with an internal antenna, the antenna being adapted to encode the data into the RFID transponder;
a memory storage device for storing at least a portion of the data;
a processing means for controlling and communicating with the memory storage device, the RFID interrogator and the internal antenna;
a means for providing a supply of RFID transponders, the transponders configured for tensile extraction;
a means for presenting the RFID transponder within an operable range of the internal antenna or near field coupler to enable encoding of the predetermined data; and
a means for detecting proximity to and adapting to movement relative to a target object to which the encoded RFID transponder is to be applied.

2. The encoder of claim 1 further comprising a wireless communication means for wirelessly exchanging tag data or the commissioning algorithm, or both.

3. The encoder of claim 1 further comprising an external housing adapted to enclose the internal antenna and further being adapted to receive a protective enclosure, the protective enclosure being adapted to enable tensile extraction of the RFID transponders.

4. The encoder of claim 1 wherein the means for presenting the RFID transponder comprises a motor assembly adapted to pull the RFID transponder from a supply reel.

5. The encoder of claim 4 wherein the supply reel rotatably mounts inside a protective enclosure, the protective enclosure adapted to releasably couple to the encoder, the protective enclosure further comprising a take-up reel.

6. The encoder of claim 4 further comprising a power supply module coupled to the motor whereby both are controlled by the processor.

7. The encoder of claim 6 wherein the power supply module comprises a rechargeable battery.

8. The encoder of claim 1 further comprising a housing assembly for enclosing the internal antenna and a handle-device mounted on a surface of the housing.

9. The encoder of claim 1 further comprising a housing assembly for enclosing the internal antenna and a mounting mechanism for selectively coupling the encoder to a provided structure.

10. The encoder of claim 1 further comprising means for controlling linear tag peel rate to the measured velocity of the housing across the face of a target object.

11. The encoder of claim 1 wherein the commissioning algorithm further comprises an encryption subroutine.

12. The encoder of claim 1 further comprising a bent transponder having shape memory to return it to an upright position non-planar to its target attachment surface.

13. The encoder of claim 1 further comprising an optical reader adapted to read printed symbols including barcodes and transmit data to the processor.

14. The encoder of claim 1 further comprising dispensing means for verifying that the RFID transponder was encoded and for dispensing an encoded RFID transponder and for not dispensing an un-encoded RFID transponder.

15. The encoder of claim 14 wherein the dispensing means further comprises a transponder peel-device for removing the encoded RFID transponder from a transport liner and a transport liner collection mechanism for spooling the transport liner on a take-up reel.

16. A system for enabling on-demand, point-of-use commissioning of RFID transponders to uniquely identify an object, the system comprising:
an RFID transponder comprising a self-adhesive layer adapted to adhere the transponder to the object, a release liner releasably coupled to the self-adhesive layer on a first side, an oppositely spaced self-adhesive layer second side couples to a carrier substrate, the carrier substrate adapted to receive an RFID chip and an antenna device, the antenna device coupling to the RFID chip and the antenna device further adapted to wirelessly send and receive data packets corresponding to an information set;
an RFID transponder encoder device having processing means and memory means, the encoder device being adapted to receive at least one RFID transponder from a first dispensing means, the encoder device further including commissioning means for commissioning the at least one RFID transponder, means for verifying the status of a commissioned transponder, means for selectively removing the release liner and for dispensing the commissioned transponder, and means for selectively capturing an un-dispensed transponder;
an RFID transponder encoding algorithm;
a means for coupling a protective enclosure adapted to contain a supply of the RFID transponders, the transponders being further adapted for tensile extraction from the protective enclosure; and
a sensor adapted to monitor the proximity to and relative motion of a target surface to adapt transponder dispensing actions.

17. The system of claim 16 further comprising an interrogator device adapted to wirelessly encode a new data set on the RFID transponder.

18. A method for commissioning RFID transponders comprising:
providing a roll or sheet of RFID transponders;
providing a protective enclosure;
providing an encoder;
inserting the roll or sheet in the protective enclosure;
coupling the protective enclosure to the encoder;
identifying information to encode;
encoding the information on at least one RFID transponder; and
adapting the process of attachment of the encoded transponder to the target surface along a vector that is nearly parallel to the target surface based upon real time feedback from the surrounding environment.

19. The method of claim 18 further comprising:
controlling the linear velocity that each transponder is dispensed based upon sensory input regarding movement relative to the target surface.
